(19) United States
(12) Patent Application Publication
(10) Pub. No.: US 2023/0056713 A1
(43) Pub. Date: Feb. 23, 2023

(54) Dynamically optimized radio receiver

(71) Applicant: Sam Belkin, San Diego, CA (US)

(72) Inventor: Sam Belkin, San Diego, CA (US)

(21) Appl. No.: 17/390,950

(22) Filed: Jul. 31, 2021

(51) Int. Cl. H04B 1/12; H04B 1/10; H04B 1/18

(52) U.S. Cl. CPC H04B 1/126; H04B 1/1036; H04B 1/18

(57) ABSTRACT

A radio frequency receiver with adaptive dynamic filtering controlled by signals from subsequent or external circuit elements, as required to suppress undesired radio frequency energy, match the radio's input circuit to the received signal, and permit optimized processing of the signal of interest.

### CROSS-REFERENCE TO RELATED APPLICATIONS

This application claims the benefit of priority of U.S. Provisional Application No. 63/061,180, filed 5 Aug. 2020 for Sam Belkin, which is incorporated herein by reference in its entirety.

### BACKGROUND OF THE INVENTION

### 1. Field

The present invention generally relates to the field of radio and microwave receivers.

### 2. Background

The first theoretical investigations of the “optimal receiver” appeared about 1930 in various publications of F. Woodword, V. Kotelnikov, N. Wiener. Though no practical execution was offered to the radio-frequency engineering community prior to the present invention, further theoretical publications on the hypothetical optimal receiver's capabilities and requirements have been published:
a. Gutkin L. Theory of Optimal Radio Receiving. Soviet Radio. Moscow, Russia. 1972. (In Russian).
b. Maxim. Improving Receiver Intercept Point Using Selectivity. Application Note 749: May 17, 2001.
c. Dawenport W., Root L. An introduction to the theory of random signals and noise. McGraw-Hill Book Co. New York. 1958.
d. Middleton D., van Meter D. Detection and extraction of signals in noise from the point of view of statistical decision. Journ. Soc. Industr. and Appl. Math. 1955, v.3, No. 4; 1956, June, v.4, No.2.
e. Slepian D. Estimation of signal parameters in the presence of noise. Trans. IRE, PGIT, 1954, No. 3.
f. Middleton D. A note of the estimation of signal waveform. Trans. IRE, JT, 1959, No. 2.
g. Shapiro I. The prediction of ballistic missile trajectories from radar observations. McGraw-Hill Book Co. New York. 1957.
h. Booton R. An optimization theory for time-varying linear systems with non-stationary statistical inputs. Proc. IRE; 1952, No. 8.
i. Blasbalg H. Experimental results in sequential detection. Trans. IRE, JT, 1959, No. 2.

In industry, literature, and in patent files, no prior art was found that teaches dynamic optimization of a radio receiver (an “optimal receiver”) as presented herein. There are many patents and methods regarding optimization of a receiver or its circuit elements, but they describe techniques for minimizing noise problems or suppressing their result, rather than elimination of the causes of such problems as achieved in the present invention. As an example of such techniques, some receiver designs employ switchable filters in the preselector or front end circuit. Since those filters switch in discrete steps, most adjustments will be compromises and the result must be less than optimal. Further, circuitry that attempts to optimize the front end of a radio with respect to the desired signal is based upon a priori knowledge of that signal, rather than an automated correction due to a detected deviation from optimal matching.

One issued US patent and one US patent application each defines a technology without which the present invention would be impossible. They are:

U.S. Pat. No. 10,622,946, by Sam Belkin, issued Apr. 14, 2020 and entitled Frequency Mixer describes a fundamentally linear radio frequency mixer technology that is incorporated into the present invention.

US Application for Utility patent Ser. No. 17/176,929, by Sam Belkin, filed Feb. 16, 2021 and entitled Dynamically Tuned Radio Frequency Filter and Applications describes a dynamically tunable radio frequency filter technology, versions of which are incorporated into the present invention.

The present invention incorporates previous Belkin technologies to construct a radio receiver that controllably matches the input signal spectrum, resulting in very high performance. Many radios have been developed using some derivative of a preselector, an input filter that limits the input spectrum. However, none provide real-time dynamic and precise controllability available from the present invention.

### Glossary

(some definitions are specific to this document)

| | |
|---|---|
| Adaptive radio | An optimal receiver, the input filtering parameters of which are |
| | dynamically modified to optimize the match between circuit |
| | characteristics and the desired signal. |
| Bandpass filter (BPF) | A filter that passes a defined band of frequencies, suppressing |
| | frequencies above and below that band. The reverse of a notch filter. |
| Clean, cleaning | In the context of signal filtering, “cleaning” means removal or |
| | suppression of components of a signal’s spectrum other than the |
| | specifically desired frequency(ies). |
| Controllable LO | A local oscillator, the frequency output of which can be manipulated |
| | by an applied control signal, e.g. a controllable frequency synthesizer. |
| Dynamically Tunable | RF filter that enables dynamic tuning of multiple parameters, in |
| Synthesized Filter | accordance with the radio input circuitry of the present invention. The |
| (DTSF) | acronym DTSF is specific to the present invention. |
| Dynamically tuned filter | An RF filter, the center frequency of which can be controlled and the |
| (bandwidth) | output bandwidth can be controlled, both by an external signal. |
| Dynamically tuned filter | An RF filter, the output center frequency of which can be controlled |
| (frequency) | by an external signal. |
| Feedback | A signal originating AFTER the point in the circuit where it is |
| | applied, thus permitting a closed loop including the controlled |
| | subsystem, component, etc. |
| Feedforward | A control signal originating BEFORE the point in the circuit where it |
| | is applied, allowing the manipulation of circuit parameters based on |
| | expectations or predictions, rather than detected performance. |
| Filter | A circuit that suppresses some radio frequencies and passes others, in |
| | accordance with its design. |
| Frequency synthesizer | A radio frequency circuit that inputs a frequency reference signal and |
| | outputs a signal at a controlled frequency. Synthesizers can be based |
| | on direct-analog, direct-digital, or phase lock loop circuitry, and some |
| | designs use combinations of those technologies. |
| Front end | In a radio receiver, the preselector or input filter and (optional) |
| | amplifier, that receives and initially processes the input RF signal. |
| Group delay | Phenomenon observed when multiple signals are applied to a channel |
| | in parallel, but appear at the output of that channel at different times. |
| High pass filter | A filter that passes frequencies above a defined point, suppressing |
| | frequencies below that point. |
| Insertion loss | The difference between amplitude of a signal applied to a circuit or |
| | device, and the amplitude of the output signal. |
| Intermediate Frequency | A general reference to the output frequency of a mixing or frequency |
| (IF) | conversion circuit. |
| Local oscillator (LO) | A signal generated by a source such as a crystal, crystal oscillator, |
| | frequency synthesizer, or the result of a signal generation process, |
| | used in the present invention as inputs to mixers. |
| Lower sideband (LSB) | One of the two major signal products of mixing signals; in this case, |
| | the LOWER (lower frequency band) of those products. |
| Lowpass filter (LPF) | A filter that passes frequencies below a defined point, suppressing |
| | frequencies above that point. |
| Microwave | A frequency band between 1000 MHz (30 cm) and 300 GHz (1 mm). |
| Millimeter wave | A frequency band between 30 GHz (10 mm) to 300 GHz (1 mm). |
| Mixer (conventional, | A converter device to mix input frequencies, producing the sum of |
| prior art) | those frequencies, the difference between them, and (because it is |
| [symbol] | inherently nonlinear), spurious signal energy. In the drawings of this |
| | document, the symbol at the left will represent a conventional mixer. |
| Mixer (linear), as used | A frequency mixer that does not add significant spurious energy to |
| in the present invention | the output signal (because it is linear in the amplitude domain). In the |
| [symbol] | drawings of this document, the symbol at the left will represent a |
| | linear mixer, typically labeled LMIX. |
| Mixer ports and labels | In this document, some drawings show symbols representing |
| [symbol] | frequency mixers, conventional or linear. In such symbols, the left, |
| [symbol] | right, and bottom ports shall be considered to have the labels RFᵢₙ, |
| | IFₒᵤₜ, and LO respectively, as shown in the symbols to the left |
| | whether or not the labels appear. |
| Noise | Combination of unwanted discrete signals (spurs) and general (e.g. |
| | thermal) noise distributed across all or part of the spectrum. |
| Notch filter | The opposite of a bandpass filter (BPF); the filter is configured to |
| | suppress a relatively narrow segment of the applied spectrum. |
| Optimal receiver | A radio receiver expressed as the present invention, in which |
| | changing signal parameters detected in the receiver section |
| | dynamically optimize filter characteristics, optimally matching the |
| | receiver circuitry to the signal. |
| Preselector | The input circuit of a radio frequency receiver. In the context of the |
| | present invention, the preselector comprises at least a dynamically |
| | tuned filter that adapts filter parameters (center frequency, bandwidth, |
| | slopes) and then gain to the characteristics of the signal, all controlled |
| | by radio receiver circuit elements after the preselector. |
| Quality (Q) | A dimensionless parameter to define filter performance, resulting |
| | from dividing a filter’s center frequency by its bandwidth. |
| Radio Frequency (RF) | Normally 1 MHz to 1 GHz, but for the purpose of this document, all |
| | frequencies from Extremely Low Frequency (ELF) to millimeter |
| | wave, including microwave bands. |
| Spectrum processing | The manipulation of spectra - RF energy. In the case of the present |
| | invention, it’s achieved by simultaneously or serially manipulating |
| | multiple parameters (relative amplitude of spectrum components, |
| | phase, waveform, etc.) of the signal being processed. |
| Spurious signals (spurs) | Discrete undesired signals generated by circuit elements and not |
| | commanded or selected. |
| Tunable filter | An RF filter, the center frequency and/or bandwidth and/or slopes of |
| | which can be controllably manipulated by external signals. |
| Upper sideband (USB) | One of the two major signal products of mixing signals; in this case, |
| | it’s the UPPER (higher frequency band) of those products. |

### Problems in Radio Design

The main and most complex problem of radio communication is reduction of noise and interference, which can obscure the signal or spectrum of interest. This problem may be mitigated by improving critical parameters of the receiver in general, and of the front end in particular. Such improvements are optimizations of the receiver, and the level of improvement of a particular parameter defines the degree of optimization of this kind. For example, a receiver with improved noise parameters can be considered to be a noise-optimized receiver. As the matching of parameters increase, the more optimized the receiver becomes. When all critical receiver parameters are perfectly matched to the signal of interest, the result—and the performance of the receiver—are optimal. Because the signal of interest is not a perfect constant, and the band of interest includes noise, perfect matching is impossible without precise dynamic control over circuit parameters.

It is generally accepted that optimization requires dynamic matching of the critical receiver's parameters with the received signal parameters. Major parameters to be matched include noise level, sensitivity, selectivity, interference immunity, bandwidth, and overall input-to-output gain. The noise quality, bandwidth, selectivity, and linearity determine the overall receiver sensitivity; linearity, and selectivity determine interference immunity; filtering system determines the bandwidth, sensitivity, selectivity, and linearity; the overall input-to-output gain determines the total receiver linearity and dynamic range. Improving some receiver parameters may negatively affect others. For example, increasing gain will worsen linearity, and vice versa. Therefore, it is necessary to find the ideal equilibrium between all critical parameters to obtain the best possible quality of the received signal. This is the main goal of all receiver designers.

In radio receiver optimization, different criteria may be used. For example, the maximum Signal-to-Interferer-to-Noise Ratio (SINR); the minimum standard error of the signal; minimum total error probability, etc. For analog receivers often the maximum SINR is the most important criterion, whereas for digital receivers it may be the minimum Bit Error Rate (BER).

The situation with the receiver's input signals constantly changes due to the statistical nature of radio links. The same is true with changes to the frequency, modulation of the signal, or location of the transmitter and/or receiver antennas. This produces complex requirements for the optimal receiver—the ability to dynamically tune critical parameters to maintain optimization. The receiver that can rapidly and dynamically tune to adapt to signal and environmental changes is the true optimal receiver, and that is the goal of the present invention. This hypothetical postulate is known in science since about the middle of the 20^{th} century, and became reality in the present invention.

In a software defined radio (SDR), signal processing can be optimized, but only after the input signal (typically from an antenna) has been shifted to be within the frequency limit of an analog-to-digital converter, thus permitting subsequent processing in the digital domain. That frequency conversion digitizes both the signal and noise, so the digitized signal of interest is corrupted by noise and other factors that reduce the performance of the overall SDR. Those limiting factors can be mitigated by incorporating derivatives of the present invention in the front end of the radio circuit in the analog domain, prior to digitizing the signal.

### Objectives of the Invention

The present invention is intended to overcome problems with, and add capabilities to, radio receivers by permitting a precise, controllable, and rapidly adaptive tunable filter that accurately matches the circuit parameters to the signal of interest, and therefore improves receiver sensitivity, selectivity, and linearity.

One objective of the present invention is to dynamically adapt the receiver input bandwidth to dynamically and automatically match the received signal spectrum, thus achieving improved selectivity compared to preselectors and similar techniques of the prior art.

Another objective is to apply to the receiver input clean signals, suppressing unwanted noise, spurs, and interferers that are present in the RF signals as they appear at the antenna.

Another objective is to make the receiver more linear with improvements in the linearity parameters: IP2, IP3, and higher Intercept Point orders, P 1 dB point where gain becomes lower by 1 dB compared to linear gain, and the Psat point where gain stops increasing.

Another objective of the present invention is to improve receiver sensitivity, thus making it more able to receive weak signals.

Another objective is to expand the dynamic range of the receiver by improving sensitivity and linearity.

BRIEF SUMMARY OF THE INVENTION

The present invention can be executed in several ways, all of which dynamically improve the match between the signal of interest and the receiver front end, and thus the performance of the system. In its simplest embodiment, the present invention is constructed by building a known conventional receiver that also includes known means for detecting non-optimal matches between the processed signal and the main receiver circuitry, and that uses known digital technologies and means to generate corrective signals, but with a radio-frequency front end that receives and reacts to those corrective signals and uses them to dynamically control applicable parameters of one or more radio frequency filter(s), such as center frequency, bandwidth, and slopes, and applicable parameters of gain control devices, resulting in a signal that excludes noise and other extraneous energy, or minimizes it, in the signal being processed. Such an optimization system may be also implemented in other parts of the receiver circuit after the preselector, within circuitry where filter performance affects system performance.

The present invention is a dynamically adaptive radio receiver system, in which the receiver front end uses linear mixers to provide dynamic filters, permitting an optimal match of the circuit to the parameters of the signal of interest.

### BRIEF DESCRIPTION OF THE SEVERAL VIEWS OF THE DRAWINGS

FIG. 1. Receiver desensitization due to unwanted distortion products.

FIG. 2. Additional selectivity requirements for a moderate-quality receiver.

FIG. 3. Additional selectivity requirements for a high-quality receiver.

FIG. 4. Dynamically Tunable Synthesized Filter (DTSF) characteristics.

FIG. 5. Synthesized Chebyshev-II filter characteristics.

FIG. 6. One version of the Dynamically Tunable Synthesized Filter as a receiver front end.

FIG. 7. Optimal Receiver.

FIG. 8. Multi-stage Dynamically Tuned Synthesized Filter (DTSF).

FIG. 9. Radio receiver with multi-stage Dynamically Tuned Synthesized Filter (DTSF) to mitigate group delay.

FIG. 10. Radio receiver comprising a software defined radio (SDR) in which the present invention suppresses all but the signal of interest, prior to digitization.

### DETAILED DESCRIPTION OF THE INVENTION

In the following description, for the purposes of explanation, details are provided to permit an enabling understanding of radio frequency receiver designs that embody the principals of the present invention. It will be apparent to one skilled in the art, however, that there are many possible variations in the execution of the present invention. However, embodiments of the present invention include a radio frequency receiver able to detect signal changes and transmit corresponding corrections to the dynamically-tunable preselector (front end), which must be able to react to those transmitted corrections by modifying its parameters and therefore overall system performance.

Throughout this description, the embodiments and examples shown should be considered as exemplars, rather than as limitations, on the receiver. That is, the following description provides examples, and the accompanying drawings show various examples for the purposes of illustration. However, these examples should not be construed in a limiting sense as they are merely intended to provide examples of the receiver rather than to provide an exhaustive list of all possible implementations of the RF receiver of the present invention.

All technical and scientific terms used herein have the same meaning as is commonly understood by one with skill in the art to which this invention belongs. In the event a definition in this document and its Glossary is not consistent with definitions found elsewhere in radio frequency literature, the definition set forth in this document will prevail for the purposes of this document.

Specific embodiments of the invention will now be further described by the following, non-limiting examples which will serve to illustrate various features. The examples are intended merely to facilitate an understanding of ways in which the invention may be practiced and to further enable those with skill in the art to practice the invention. Accordingly, the examples should not be construed as limiting the scope of the invention. In addition, reference throughout this specification to “one embodiment” or “an embodiment” means that a particular feature, structure, or characteristic described in connection with the embodiment is included in at least one embodiment of the present invention. Thus, appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

One embodiment of the present invention uses a tunable preselector, or front end, comprising combinations of linear mixers, filters, and controllable or fixed local oscillators, as required to improve an input signal, such as from a broadband antenna, to adapt that preselector to the characteristics of the input signal, where one possible function of several is the removal or suppression of extraneous noise from that input signal. Implementations of the present invention permit a rapid controllable change of the filter's center frequency and bandwidth while optimizing signal integrity and adding insignificant noise to the process. Other embodiments of the present invention add controllable attenuators, phase shifter(s), inductors, and switches to the basic front end circuit, expanding its function beyond filtering to permit complex spectrum processing. The present invention allows the designer to use known techniques to generate control signals that rapidly and precisely shift the manipulated spectrum along the frequency axis, without adding significant noise from nonlinear devices in the circuit.

Signals are (optionally) amplified or suppressed by modifying the spectra in the frequency domain. Filtering does it in frequency and amplitude domains. Mixers do it mostly in the frequency domain. All these circuits work in one or two domains and may be considered as one or two-dimensional processes. The present invention allows designers to consider multi-domain or multidimensional processing, via filters and mixers and the circuitry that manipulates them.

To properly execute the present invention, certain operational parameters must be understood.

The sensitivity of the radio receiver depends on thermal noise density, bandwidth, ambient temperature, and the receiver's linearity. The thermal noise density may be defined as

N₀=k·T (1)

where: k—is the Boltzmann's constant, k=1.3806505*10\hat{ }23 J/° K,
T—is the ambient temperature, ° K.

For normal room temperature of 290° K the thermal noise density is therefore

N₀=k·T=1.3806505·290=4.004·10⁻²¹W (2)

Or, in the logarithmic numbers

N_{0 dB}10·log(N₀)=174 dBm/Hz (3)

The actual thermal noise floor of the receiver may be found with consideration of the required baseband bandwidth B

N=N₀·B W (4)

Or, in logarithmic form

N_{dB}=10·log(N₀·B) dBm (5)

When, for example, bandwidth is equal to 1 MHz, the thermal noise floor of the receiver will be equal to 174−60=114 dBm. This value is the maximum possible receiver sensitivity for a given temperature and bandwidth and with the assumption that the receiver itself is ideal and does not add any noise. The real receiver has noise, usually defined by the noise figure NF. Adding this noise to the theoretical thermal noise floor we arrive at the Minimum Discernible Signal (MDS):

MDS=N_{dB}+NF dBm (6)

This shows that only a few factors control receiver sensitivity. The Boltzmann's constant cannot be changed—this is the parameter of our planet. We may change the temperature, as in cryogenic receivers used in radio astronomy. However, for most radio receivers, changing the temperature is not practical. We have control over bandwidth, but it depends on the required quantity of the data to be received per unit of time and the required quality of the received signal. We also may improve the receiver's noise figure by choice and design of the receiver's front end.

However, there are other, often overlooked, factors that seriously affect the achievable receiver sensitivity, including selectivity and linearity. It is a well-known fact that when strong signals are applied to the receiver input, harmonic and intermodulation distortions occur and parasitic products are created. These products, usually called spurs, are unwanted discrete signals. Therefore, we must consider them as non-thermal electrical noise. This noise adds to the thermal and receiver's internal noise and elevates the overall noise floor. Often this process is called “desensitization,” because it reduces the achievable receiver sensitivity. Depending on the actual power of the unwanted signal applied to the receiver's input, desensitization level may define opportunities for sensitivity improvements as attained by the present invention.

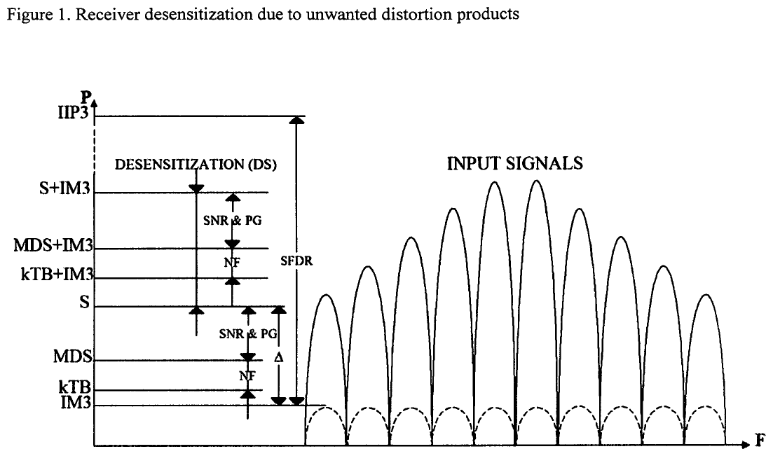

The receiver desensitization process due to unwanted distortion products is shown in FIG. 1. The signals at the receiver input are shown with the created unwanted distortion products. The levels of thermal noise floor kTB, MDS, and Sensitivity S are presented at the left part of the picture for two cases: with and without the unwanted distortion products.

Harmonics and Inter Modulation Distortion (IMD) products may be significant in level and can dramatically reduce the receiver's ability to receive weak signals. This problem can be mitigated by increasing the selectivity and linearity of the receiver, as achieved by the present invention. Selectivity for the input circuits is limited by the achievable equivalent quality factor of the input filters. This limitation is very serious, especially for tunable filters. In practice, switchable bandpass filters are used in most designs. This solution provides partial improvement for the selectivity and sensitivity, but it is obviously limited because of switching intervals. Also, the switching circuits and mechanical equipment introduce their own unwanted effects on the quality of the receiver.

Increasing selectivity will also increase the equivalent Intercept Points (IPn), commonly used measurements of receiver linearity. The concept of IP was introduced by Dr. Friis in 1944 and widely used since then, as an excellent geometrical representation of the linearity of electronic devices. For sensitivity and selectivity evaluation purposes, the most important are the second and the odd-order intercept points and products because these products are located close to the desired signals. These intercept point levels and actual distortion products depend on selectivity. The level of intermodulation products of nth-order is:

IMₙ=n·P−(n−1)·IPₙ dBm (7)

where: P is the power in dBm of RF signals (tones) applied to the receiver's input, and IPn is the Intercept Point of nth-order also in dBm, as a measure of receiver linearity.

From (7) it is clear that the intermodulation products (IMn) level depends on the order n of IMD products and the IPn linearity parameters of the receiver. Even without input selectivity, the negative effects of IMD products will diminish with higher orders of the IMD products and higher levels of IPn parameters (better linearity). Unfortunately, this reduction of negative effects only partly solves the problem, and significant improvements in input linearity are necessary to approach optimization. Input linearity improvements can be achieved by adding input selectivity to the front end, or preselector, of the receiver. As a result, bandwidth becomes narrower and the IMD product levels are reduced. As the bandwidth narrows (better selectivity) there is less space (spectrum) available for unwanted products to reach the receiver input.

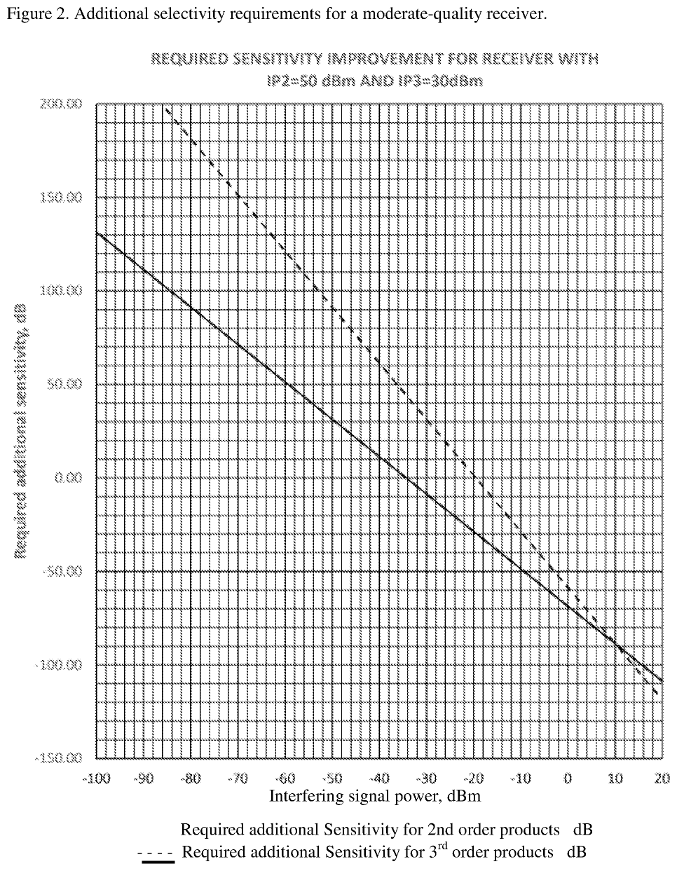

Additional selectivity will also decrease the power level of the second-order and third-order intermodulation distortion IM2 and IM3. To show that resulting IP2 and IP3 points are improved equations (8) and (9) are understood, and as shown in FIG. 2:

IP2ₑ=IP2+2·S_{db} dBm (8)

IP3ₑ=IP3+⅔·S_{dB} dBm (9)

IM2=2·P−IP2ₑ=2·P−IP2−2·S_{db} dBm (10)

IM3=3·P−2·IP3ₑ=3·P−2·IP3−3·S_{db} dBm (11)

Equations (10) and (11) show that adding the selectivity S_{dB} allows significant improvement in receiver linearity. Improvements of the second-order IM2 are 2 dB per 1 dB of selectivity S_{dB} increase, and for the third-order IM3, it is a 3 dB improvement per 1 dB of selectivity S_{dB} increase. Such linearity improvements can generally avoid desensitization, leading to important improvements in receiver performance.

To determine the required level of additional selectivity to avoid desensitization of a receiver with known parameters, consider that 1 shows that intermodulation products elevate the receiver noise floor. The desensitization started well before the IMD product level reaches the MDS. For example, when IMD products are 10 dB below the MDS, desensitization is about 0.46 dB. The desensitization degree can be evaluated by the superposition method. As a result, for maximum allowable desensitization amount δ the maximum IMD product level must be below the MDS by:

$$Δ = 10 \cdot log ( \frac{1}{1 - 1 {0}^{0.1 \cdot ( - δ )}} ) dB \qquad ( 12 )$$

The maximum allowable level of the IMD products that are below MDS by the value of δ is equal to:

IMD_{MAX}=MDS−Δ dBm (13)

Knowing these values, the possible power of interfering signals P, and receiver second-order distortion IP2 and the third-order distortion IP3 we may determine required second-order and third-order selectivity numbers in dB:

Sr2_{dB}=MDS−Δ−2·P+IP2 dB (14)

Sr3_{dB}=MDS−Δ−3·P+2·IP3 dB (15)

In equations (14) and (15) the intercept points IP2 and IP3 are the actual parameters of the given receiver, not the improved values IP2e and IP3e. The results of the simulation with newly derived equations (14) and (15) are presented in FIG. 2 for a moderate-quality linear receiver with IP2=30 dBm and IP3=10 dBm. The bandwidth is 1 MHz, the noise figure is 5 dB, the receiver is at room temperature, and the maximum allowable desensitization amount was chosen to be −0.5 dB.

There are two lines in FIG. 2: one is for the second-order effects of additional selectivity Sr 2dB and the other is for the third-order effects from this added selectivity Sr 3 dB. For the power of the interfering signal below −10 dBm, required selectivity is determined by the second-order IMD. At −10 dB level, both lines become equal and after the −10 dB power level, the third-order IMD dominates the process. Note that the 0 dB selectivity level is the border between the required selectivity zone below the zero dB line and the margin selectivity zone is above this line. It is easy to see that for this particular moderate-quality receiver additional selectivity is necessary for the interfering levels above −44 dBm. At the interfering signals level of −10 dBm, required additional selectivity is about 68 dB, a limitation for moderate-quality, moderate cost, receivers.

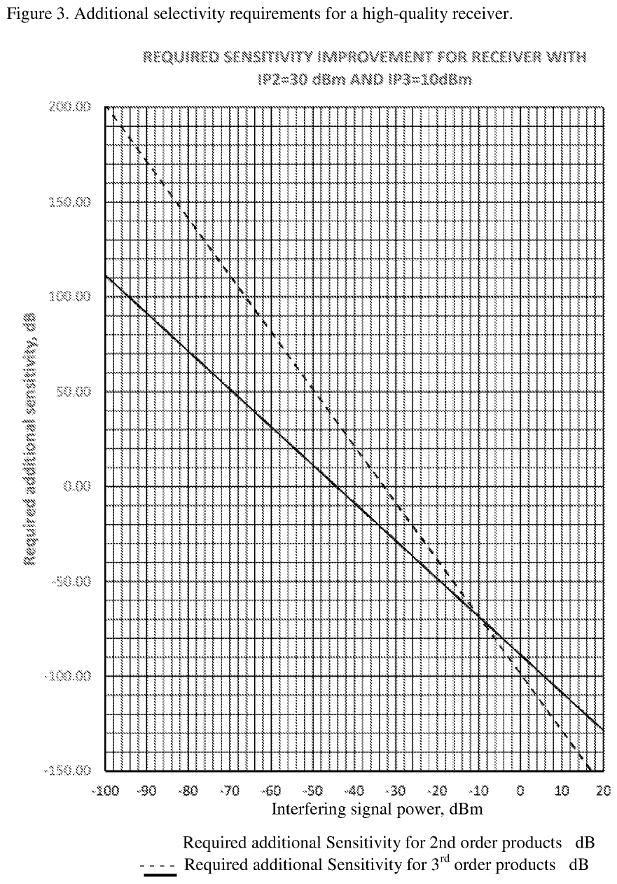

For illustration purpose, the analogous simulation was done for a significantly better quality receiver with the same parameters except for IP2 and IP3 levels that were chosen to be equal IP2=50 dBm and IP3=30 dBm (each 20 dB higher than previous). The plots of this simulation are presented in FIG. 3.

For the high-quality receiver, interfering signals power that requires additional selectivity are shifted 10 dB higher to −34 dBm. Intercept point of two lines are at the 10 dBm level which is 20 dB higher. For the −10 dBm level of the input signal, required selectivity now is 20 dB lower, only −48 dB.

Analogously, we may determine required additional selectivity in the case with multiple interfering tones, for example, with multichannel interferer(s). Multiple tones interference characterize with Composite Triple Beat (CTB) or Composite Third Order Distortion CTD). The interference power level in this case can be determined for the middle part of the band in dB below the carrier level (dBc):

CTBₘ=−2·(IP3−Pc)+20·log(N)+1.74 dBm (16)

where: N is the number of carriers,

Pc is the power level of each carrier.

Analogously, for the edge of the bandwidth:

CTBₑ=−2·(IP3−Pc)+20·log(N) dBm (17)

When the total power of the interference signal is known or preferable to be used, the following equation can be used to determine the total interference power level P_{T}:

P_{T}=Pc+10·log(N) dBm (18)

And corresponding to it, CTB:

CTBₘ=−2·(IP3−P_{T})+1.74 dBm (19)

CTBₑ=−2·(IP3−P_{T}) dBm (20)

When the required level of additional selectivity is known, feasibility of realization can be evaluated. Consider a receiver's channel bandwidth at baseband of about 1 MHz, with the requirement to eliminate interference from an adjacent channel. In this example, we seek to eliminate the interfering signal that is 1 MHz from our frequency of interest. The desensitization analyses showed that we need an additional 60 dB of selectivity. It means that at the receiver input there must be a filter with slopes of 60 dB/MHz. The realization of such a filter at RF frequencies is not possible. But with a channel bandwidth of 10 MHz, the slope requirements reduce to 6 dB/MHz. That filter is also well beyond the capabilities of conventional filter technology. However, the dynamic filtering synthesis technology within the present invention provides steep slopes up to 60 dB at 5% distance from the cutoff frequency of the filter, and that makes such filter performance possible.

The present invention includes a dynamically tunable filtering system that can adaptively adjust central frequency, bandwidth, and even the steepness of slopes−all at high speed. Combining that filtering system—effectively the preselector—with a good contemporary receiver allows dynamic tuning of receiver parameters to match signal changes. A receiver with this system integrated will avoid desensitization and have very high linearity: the result is the optimal receiver of the present invention.

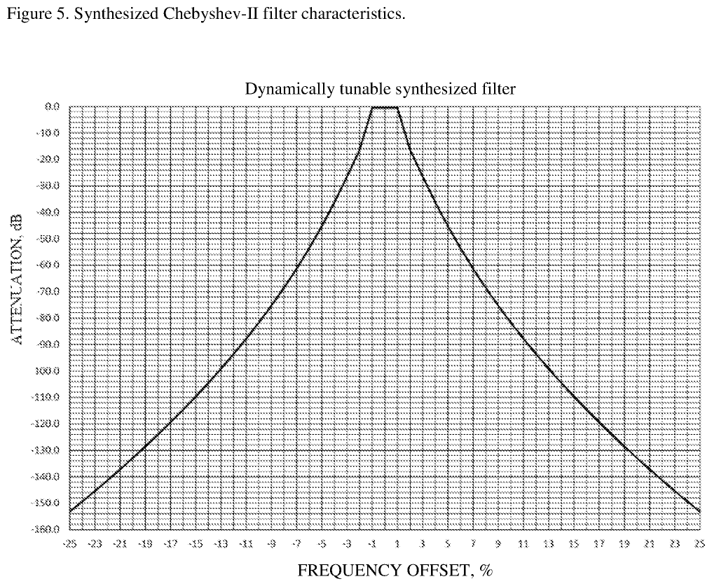

One of the possible practical realizations of a dynamically tunable synthesized filter (DTSF) incorporated in the present invention has characteristics presented in FIG. 5, which shows that for a 10% offset, the DTSF provides about 82 dB of attenuation. The shown characteristic is in the normalized form and does not depend upon the central frequency for a wide range of RF applications. The center frequency is 10 MHz and 10% offset is 1 MHz. In this case, we get about 8.2 dB/MHz steepness of the filter slope. This is more than needed and is unachievable with conventional filter technology in the prior art. The shown example is not the best possible with the present invention—it is about average. When system performance so dictates, the present invention can use a dynamically tuned synthesized filter (DTSF) with 130-150 dB attenuation at 10% frequency offset. Comparison shows that with the DTSF front-end system, combined with a high-quality receiver, all problems with intermodulation distortion are solved and that parameter will not affect receiver performance: thus, the optimal receiver.

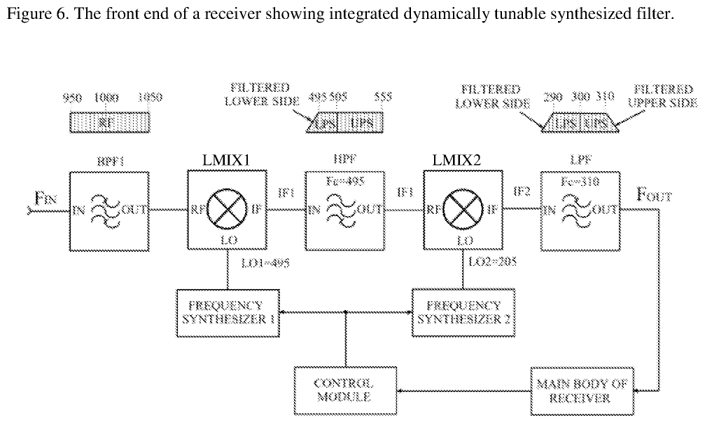

FIG. 6 shows the present invention using a single two-mixer filtering cell, among the simplest embodiments of the present invention. The first mixer LMIX1 downconverts the input signal to the first intermediate frequency IF1, which is filtered in highpass filter HPF. In the example, this filter removes the lower part of the signal spectrum between 950 and 990 normalized frequency units. The cutoff frequency of this filter in this example is 495, therefore, it will pass signals with frequencies higher than 990−495=495. As a result, the IF1 spectrum after the HPF will occupy the spectrum from 495 to 1050−495=555 as shown. Then this spectrum downconverts again by mixer LMIX2 and is fed to lowpass filter LPF with a cutoff frequency of 310. This will filter the IF3 spectrum after the cutoff frequency, and the resulting spectrum is from 495−205=290 to 310. By changing the LO1 frequency, the filtered part of the lower side of the input spectrum can be modified accordingly. The same is true for the LO2 frequency that controls the tuning of the upper side of the initial spectrum. The achievable bandwidth range will be equal to the sum of the LO1 frequency offset and frequency offset of LO2. By synchronously changing both LO1 and LO2 frequencies, the central frequency of the output spectrum can be moved to the desired point.

With the addition of such a filter, plus the use of other well-known technologies for automatically manipulating certain parameters, for example, Automatic Gain Control (AGC) and

Automatic Frequency Control (AFC) systems, the result is substantially superior to all prior art designs. When all optimizations are dynamically tunable to rapidly adapt to any signal changes, the result will be the OPTIMAL RECEIVER—the present invention.

The optimal receiver comprises a conventional radio frequency receiver with additional known circuitry to detect deviations from optimum and then using known means to create corrective signals, plus a front end in accordance with the present invention that includes one or more dynamically tuned synthesized filter(s) (DTSF) as shown in FIG. 6, enabling removal or suppression of unwanted radio frequency energy and therefore optimizing radio performance.

### Embodiments and Variations

The present invention can be executed as a radio frequency front end (RF input, filter, etc.) including gain control (amplification, attenuation) as required, as the embodiment shown in FIG. 6, and then added to a conventional (non-optimal) radio receiver, modified to detect and generate control signals to compensate for signal errors. It can also be executed as an addition to or improvement of other radio circuits in which filter performance can affect overall system performance. Finally, the present invention can be executed as a complete radio frequency receiver, front end of which is highly selective using the dynamically tuned synthesized filter (DTSF) as shown in FIGS. 6, 7, 8, and 9. Note that a practical DTSF can be constructed only by using linear mixer technology.

The present invention can be executed as a complete radio, in which each stage that requires an RF filter includes the DTSF to improve filter performance and therefore overall receiver performance.

In all embodiments of the present invention, each DTSF requires control signals to manipulate filter parameters.

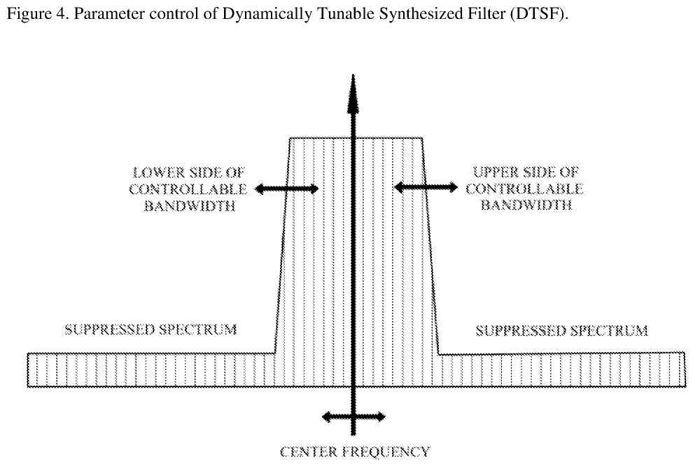

In all embodiments, each DTSF provides the functionality defined in FIG. 4.

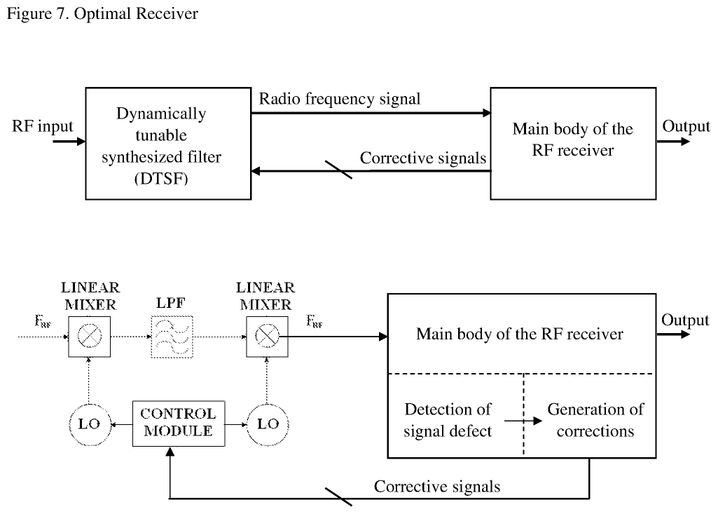

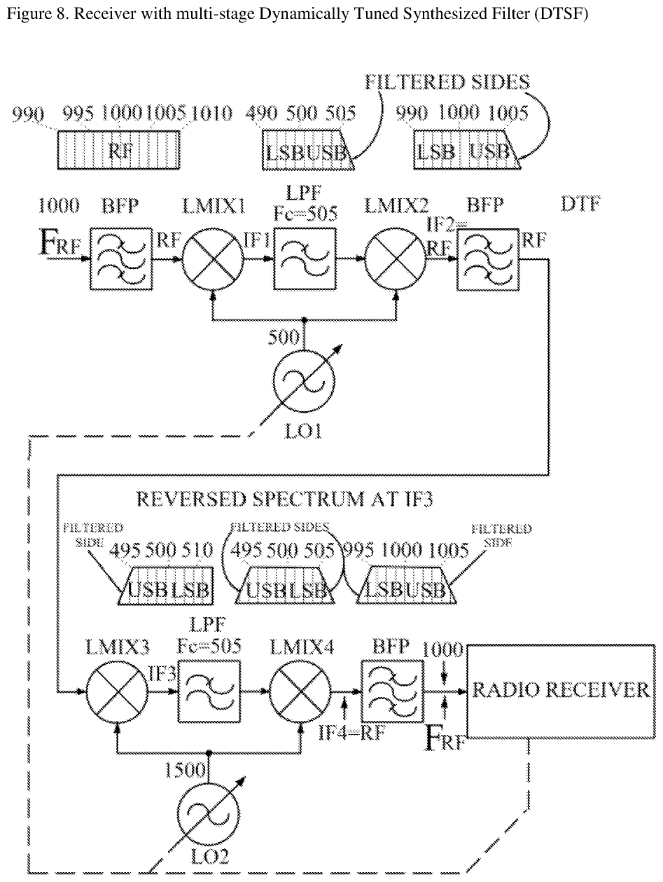

The present invention can be executed using more complex and even higher performance versions of the DTSF as shown in FIGS. 7 and 8. Those figures show further enhancement of the selectivity and sensitivity of the front end, achieved by using multiple stages of the DTSF.

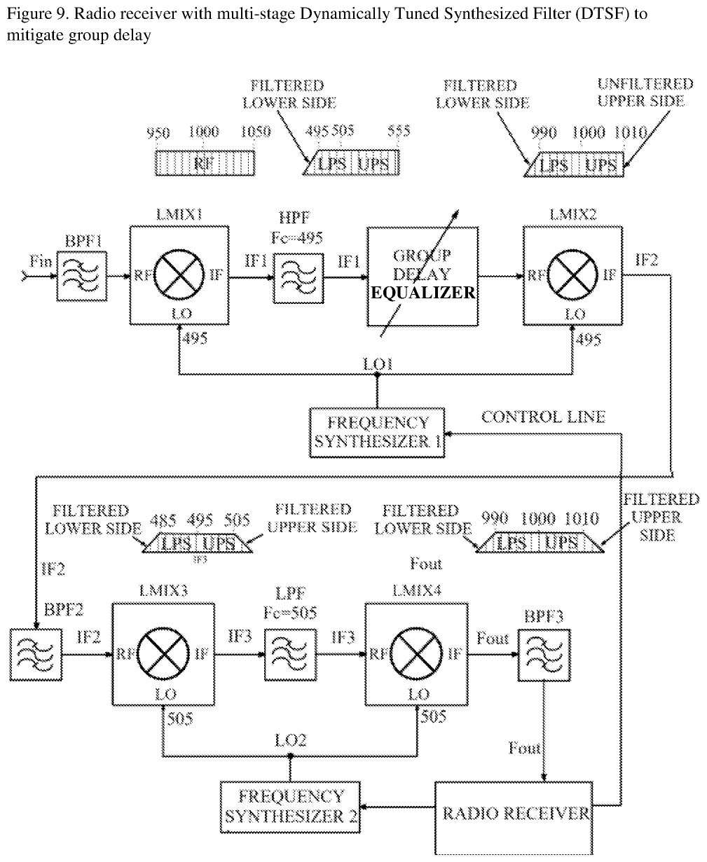

FIG. 9 shows one method of mitigating group delay using the present invention.

In all embodiments of the present invention, the receiver circuitry includes known methods for detecting changes in the signal, and known methods for generating corresponding control signals that determine DTSF operation.

There are too many possible embodiments and derivatives of the present invention to permit encyclopedic disclosure herein. The present invention is intended to encompass all radio receiver and test instrument circuits in which the parameters of the input circuits are dynamically matched to the characteristics of a generated or detected signal, thus minimizing all noise that is part of the original spectrum. The present invention can be expressed as the front end of a radio, in which controllable linear mixers are combined with, or used as part of, active and controllable filters, with the main body of the receiver able to detect differences between the signal characteristics and the front end parameters, and send control signals to the front end to dynamically optimize that match. Therefore, the present invention encompasses any radio frequency receiver in which the parameters of the front end are dynamically manipulated to optimize the match between the circuitry and the characteristics of the incoming signal. It also encompasses any radio circuit element beyond the preselector in which filter parameters are automatically adjusted to optimize performance.

### DRAWINGS

FIG. 1. Receiver desensitization due to unwanted distortion products.

This drawing shows how receiver desensitization occurs due to intermodulation distortion products. On the right side of the picture input, the RF signal is shown as a big ellipsoidal form. These signals may be of any kind: the single tone sinusoidal, multifrequency CW, or burst signals. The plurality of these signals creates intermodulation distortion (IMD) products. They are shown as lines inside the RF input signals. These lower-level signals are all unwanted, therefore, noise power. Their level marked as IM3 on the left side of the picture. The number 3 in this name was chosen mainly because the third order of IMD is more important and used for determination of the Spur Free Dynamic Range (SFDR)—an important measure of linearity.

In most well-designed receivers this IMD level must be below the kTB level which is the thermal noise floor of the receiver. This level is also shown on the left side of the picture just above the IM3. The next signal power level is Minimum Discernible Signal and it marked as MDS. This power level exceeds kTB by noise figure (NF) value. The receiver sensitivity is this MDS level plus required Signal-to-Noise Ratio (SNR) and processing gain (PG). This signal power level is marked as S. The next three lines are the same as discussed plus the unwanted IMD products level IM3. From these lines one can see how much the receiver sensitivity line S+IM3 is higher compared to the no IMD case S.

Finally, on the top left part of the drawing IP3 level is shown. This is the Intercept Point of the third order—the important parameter of the receiver's third-order nonlinearity that mostly affects sensitivity. The difference between IP3 and IM3 levels defines the SFDR of the receiver.

FIGS. 2 and 3. Additional selectivity requirements for a moderate-quality receiver.

These drawings show two plots for different linearity levels of two hypothetical receivers. To mitigate the negative effects of intermodulation products, a receiver needs additional selectivity at its input. The first plot is for the first receiver that has IP2 level=30 dBm and IP3 level=10 dBm. These numbers are average for receivers. The second plot is for the second receiver with better linearity—IP2=50 dBm and IP3=30 dBm. This is one of the best receivers available today.

There are two lines on the plots: the solid line is for the second-order effects of additional selectivity Sr2dB and the dashed line is for the third-order effects from added selectivity Sr3. For the first moderate-quality receiver for the power of the interfering signal below −10 dB required selectivity is determined by the second-order IMD. At the −10 dB level, both of the lines become equal and after −10 dB power level, the third-order IMD dominates the process. The 0 dB required selectivity horizontal line represents the border for the required selectivity zone. If the vertical line that corresponds to the interferer's power crosses the additional selectivity lines above this zero line, receiver is okay. If it crosses below the zero required selectivity line, additional selectivity is required. The required level can be determined from the vertical axis at the crossing point with corresponding additional selectivity line.

For this particular moderate-quality receiver plot additional selectivity is necessary for the interfering levels above −44 dBm. At the interfering signal level, of −10 dBm required additional selectivity is about 68 dB, a limitation for moderate-quality, moderate cost receivers. For the high-quality receiver plot on page 28, interfering signals power that requires additional selectivity shifted 10 dB higher to −34 dBm. The intercept point of the two lines are at the 10 dBm level which is 20 dB higher. For the -10 dBm level of the input signal, required selectivity now is 20 dB lower—only −48 dB.

By these standards, the present invention permits economical performance well beyond that of prior art receivers.

FIG. 4. Dynamically Tunable Synthesized Filter (DTSF) characteristics.

This drawing shows how the central frequency and edges of the filter bandwidth are adjustable by using the Dynamically Tunable Filter (DTF). These parameters can be tuned as shown, permitting precise control by subsequent radio circuitry over the signal passed by the filter.

FIG. 5. Characteristics of the present invention front end using a dynamic synthesis of a Chebyshev-II filter.

This drawing shows characteristics of a controllable dynamic filter as used in the front end of the present invention, with synthesis of a Chebyshev-II polynomial-based bandpass filter function. This drawing shows a high-quality bandpass filter that has attenuation of more than 80 dB at 10% frequency offset. That level of filter performance is not feasible at high RF frequencies. The filters comprising the front end of the present invention can synthesize this quality of frequency response.

FIG. 6. The front end of a receiver using a dynamically tunable synthesized filter.

This drawing shows one realization (of many that are possible) of a radio front end using a dynamically tunable filter (DTF) that synthesizes a high-quality bandpass filter. This DTF comprises two linear mixers LMIX1 and LMIX2 that are controlled by frequency synthesizers 1 and 2. These synthesizers are controlled by control signals generated by the main body of the receiver. The highpass HPF and lowpass LPF filters are placed at the mixers' outputs to cut unwanted parts of the signal spectrum. An input bandpass filter (BPF) is optional and may help to limit outside signals applied to the system. This implementation provides tunable filtering along with frequency conversion and can be simultaneously used as the receiver's front end and the first frequency converter.

### FIG. 7. Optimal Receiver.

This drawing shows one possible realization (of many) of a radio with integrated Dynamically Tunable Filtering System (DTFS), in this case using two linear mixers and a highpass (HPF) or lowpass (LPF) filter. Linear mixers use LO signals that are controlled by signals generated by subsequent known circuitry in the receiver and converted in the control module. This implementation permits tuning the filter center frequency.

FIG. 8. Multi-stage Dynamically Tuned Synthesized Filter (DTSF) to improve radio performance.

This drawing shows one possible realization of a Dynamically Tunable Filtering System (DTFS) with four linear mixers and two lowpass (LPF) filters. Each of two mixer+LPF cells cuts one side of the signal spectrum, together they form the required bandwidth for the system. The second cell also reverses the signal spectrum passing the second LPF and the last linear mixer LMIX4 reverses the spectrum back to its initial form. Input and output BPFs are optional, they help to limit input and output signals spectra. This implementation has the same RF signals frequency at the input and the output, therefore, does not perform frequency conversion.

In this case, linear mixers use LO signals generated by controlled frequency synthesizers. This implementation of the present invention permits tuning of both the filter center frequency and bandwidth.

FIG. 9. Multi-stage Dynamically Tuned Synthesized Filter (DTSF) to mitigate group delay.

This drawing shows one possible realization of a Dynamically Tunable Filtering System (DTFS) with four linear mixers, highpass filter (HPF), lowpass filter (LPF), and a group delay equalizer. This configuration can be used without the group delay equalization just as the DTFS with HPF and LPF filters. In that configuration, spectrum of processing signals is not reversed in any part of the circuit.

The first two mixers LMIX1 and LMIX2 with HPF cut the lower side of the signal spectrum. Then mixers LMIX3 and LMIX4 with LPF cut the upper side of the signal spectrum. The first mixers cell also provides group delay equalization for the spectrum of interest.

This implementation has the same RF signals frequency at the input and the output, therefore, it does not perform the frequency conversion.

This implementation allows tuning the filter center frequency and bandwidth as well as equalization of group delay.

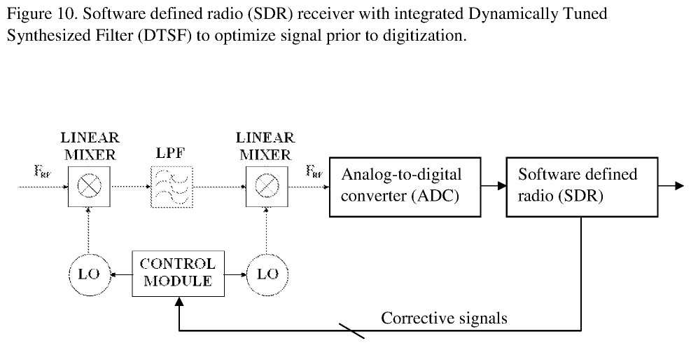

FIG. 10. Software defined radio receiver with Dynamically Tuned Synthesized Filter (DTSF) to optimize signal prior to digitization to produce a digitized signal with reduced noise.

### CONTENT AND LANGUAGE

The terms “including,” “comprising,” and variations thereof as used in the claims should not be interpreted as being limitative to the means or elements listed thereafter. Thus, the scope of the expression “a device comprising A and B” should not be limited to devices consisting only of components A and B. It means that with respect to the present invention, the only relevant components of the device are A and B. That is, the terms “including”, “comprising” and variations thereof mean “including but not limited to”, unless expressly specified otherwise.

Thus, use of the term “comprising” indicates that the listed elements are required or mandatory, but that other elements are optional and may or may not be present. The terms “an embodiment”, “embodiment”, “embodiments”, “the embodiment”, “the embodiments”, “one or more embodiments”, “some embodiments”, and “one embodiment” mean “one or more (but not all) embodiments of the present invention(s)” unless expressly specified otherwise. The terms “a”, “an” and “the” mean “one or more”, unless expressly specified otherwise. Devices that are in communication with each other need not be in continuous communication with each other, unless expressly specified otherwise. In addition, devices that are in communication with each other may communicate directly or indirectly through one or more intermediaries. A description of an embodiment with several components in communication with each other does not imply that all such components are required.

On the contrary, a variety of optional components are described to illustrate the wide variety of possible embodiments of the present invention. One skilled in the art will appreciate that the present invention can be practiced by other than the above-described embodiments, which are presented in this description for purposes of illustration and not of limitation. The specification and drawings are not intended to limit the exclusionary scope of this patent document. It is noted that various equivalents for the particular embodiments discussed in this description may practice the invention as well. That is, while the present invention has been described in conjunction with specific embodiments, it is evident that many alternatives, modifications, permutations and variations will become apparent to those of ordinary skill in the art, in light of these descriptions.

Accordingly, it is intended that the present invention embrace all such alternatives, modifications and variations as fall within the scope of the appended claims, and—in particular—all modifications that add known filter circuitry to the input to the invention or to its output. The fact that a product, process or method exhibits differences from one or more of the above-described exemplary embodiments does not mean that the product or process is outside the scope (literal scope and/or other legally-recognized scope) of the following claims. For example, the components of the systems and apparatuses may be integrated or separated. Moreover, the operation of the RF filter and apparatuses disclosed herein may be performed by more, fewer, or other components and the methods described may include more, fewer, or other steps. Additionally, steps may be performed in any suitable order.

Any one or more of the foregoing embodiments may well be implemented in silicon, hardware, firmware, software and/or combinations thereof. The particular illustrated example embodiments are not provided to limit the invention but merely to illustrate it. Thus, the scope of the present invention is not to be determined by the specific examples provided above but only by the plain language of the following claims.

To aid the Patent Office and any readers of any patent issued on this application in interpreting the claims appended hereto, applicants wish to note that they do not intend any of the appended claims or claim elements to invoke 35 U.S.C. 112(f) unless the words “means for” or “step for” are explicitly used in the particular claim.

1. A radio receiver circuit that dynamically adapts to a selected incoming radio frequency (RF) signal by matching receiver input bandwidth with received signal spectrum, and automatically suppressing spectra other than said signal of interest, comprising:
an input port for receiving the applied RF signal;
at least one initial RF mixer connected to said input port, configured to convert the signal to a new point in the spectrum at which dynamic filtering is optimal;
a controllable local oscillator (LO) signal that controls the parameters of said at least one initial RF mixer;
at least one RF filter connected to the output of said initial mixer, configured to suppress signals other than the signal of interest;
at least one secondary mixer to receive the output of said RF filter and convert it to a new desired point in the spectrum;
a controllable local oscillator (LO) signal that controls the parameters of said secondary RF mixer; and
an output port from which the filtered signal of interest generated by said secondary RF mixer is applied to subsequent circuitry of the receiver.

2. The circuit of claim 1 wherein:
the first and second mixers are both controlled by a common LO of controllable frequency;
the first and second mixers are each controlled by an independent LO of controllable frequency; and
a port on each said local oscillator that permits control of its output frequency, thus controlling the operating parameters of the connected RF mixer and therefore controlling filtering parameters.

3. The circuit of claim 1 wherein the signal that controls a controllable local oscillator, and therefore the parameters of connected mixers and filter, is derived via:
a known detection circuit at a subsequent point in the receiver signal path, configured to determine less-than-optimum matching between the circuit and the signal of interest; and
a known error-correction signal generation circuit that converts the result of said error detection into a control signal that is applied to said controllable local oscillator to manage the parameters of the mixer-based filter it controls.

4. The circuit of claim 1 wherein:
the characteristics of the applied RF signal are known due to external information from analysis or knowledge provided by external means; and
the signal that controls at least one said controllable local oscillator is derived from said external information or knowledge.

5. The circuit of claim 1, wherein said filter is a:
bandpass filter;
lowpass filter;
highpass filter; or
notch filter.

6. The circuit of claim 1, wherein at least four controllable mixers and at least one filter are configured to add filtering steps to further optimize the controllable dynamic filtering of the signal of interest.

7. The circuit of claim 1, wherein the radio frequency receiver front end includes a signal path via a controllable mixer-based filter to suppress all spectra other than that of interest, in which the dynamic filter configuration includes:
two mixers in series, with filter between them; and
two, two-mixer series cells in series, with filter(s) between them.

8. The circuit of claim 1, wherein a radio frequency receiver signal path includes at least one dynamically-tunable synthesized filter at a point after the first frequency converter and before the demodulator/baseband circuit, to provide controllable filtering.

9. The radio frequency circuit of claims 1-8 that includes active dynamic filtering in at least one stage, wherein the control signal generation circuit of said dynamic filtering is disposed in a closed loop that includes known circuitry configured to detect signal amplitude, phase, and frequency and transmit changes to the control unit, enabling said control unit to dynamically change parameters of the LO based upon feedback signals.

10. The radio frequency circuit of claims 1-9, wherein the control signal generation circuit of said dynamic filtering is controllable by known external circuitry to dynamically change parameters of the LO based upon external signals.

11. The radio frequency receiver circuits of claims 1 to 10, wherein a dynamic filter in series with the signal path is configured for spectrum processing using:
time-division method; and
frequency-division method.

12. The circuit of claims 1 to 11 followed by analog-to-digital conversion in a software defined radio (SDR) in which a detected signal is subjected to controllable dynamic filtering in the analog domain, thus reducing the noise in the resulting digitized signal.

13. A radio receiver, radar receiver, or electronic test instrument in which the signal path includes the controllable dynamic filtering of claims 1 to 11, thus optimizing the functions of subsequent circuitry, wherein:
the signal has been received, as from an antenna;
the signal is generated internally, as by an oscillator; and
controllability is achieved by application of control signals applied to at least one LO controlling at least one mixer in a mixer-based dynamic filter in series with the signal of interest.

14. The dynamic filtering circuit of claims 1 to 11 followed by a radio receiver, radar receiver, or electronic test instrument, resulting in input bandwidth that is dynamically, controllably, and precisely matched to the applied signal spectrum, wherein:
the input bandwidth is determined by a filter the parameters of which are controllable in real time; and
the bandwidth-determining filter's parameters are controlled by circuitry that both detects deviations from optimal matching and generates control signals applied to said filter.

15. A radio frequency receiver circuit to equalize and mitigate group delay, wherein:
the signal path includes at least one dynamically tunable synthesized filter using at least two linear mixers; and
a group delay equalizer circuit is positioned between said two linear mixers.
